(19) United States
(12) Patent Application Publication
(10) Pub. No.: US 2023/0374857 A1
(43) Pub. Date: Nov. 23, 2023

(54) Treestand and climbing stick with integrated climbing hook

(71) Applicant: Andrae T. D'Acquisto, Bellevue, IA (US)

(72) Inventor: Andrae T. D'Acquisto, Bellevue, IA (US)

(21) Appl. No.: 17/803,338

(22) Filed: May 17, 2022

(51) Int. Cl. E06C 1/34; E06C 1/38; A01M 31/02

(52) U.S. Cl. CPC E06C 1/34; E06C 1/381; A01M 31/02

(57) ABSTRACT

The present invention generally relates to a climbing stick for use in climbing trees for hunting or other purposes with comprises a climbing hook. The invention also relates to a treestand, including a micro or saddle treestand comprising a climbing hook. The climbing hook is configured to allow a stand or sticks to attach to a waist belt, mole webbing, safety harness, backpack, saddle, pocket, etc. or any similar item on your person, which allows the hunter to have both hands free while ascending a tree to set up your treestand and/or sticks.

### FIELD OF THE INVENTION

The present invention generally relates to a treestand and climbing stick having integrated climbing hooks for use in climbing trees for hunting or other purposes. The integrated climbing hook makes setting up a treestand and climbing sticks safer and more efficient.

### BACKGROUND OF THE INVENTION

Climbing sticks are designed for use in climbing trees for hunting and are available in an wide variety of types, providing a myriad of sizes, shapes, materials of construction, mounting mechanisms and other features. Key among the important features to be considered by a hunter in choosing climbing sticks are safety, weight, simplicity of construction and use, quietness and camouflage or capability of masking the construction from hunted game. The considerations of safety and weight are often conflicting because adequate strength frequently requires the use of heavier and stronger structural members. Lightweight structural materials are, therefore, used almost exclusively in the construction of climbing sticks. To balance the considerations of strength, weight and cost, structural aluminum has been the material of choice. As a result, the majority of climbing sticks on the market today are of aluminum or steel construction.

Setting up climbing sticks and/or a treestand can present a physical challenge and a safety issue. More specifically, a hunter is typically forced to climb a tree with a climbing stick in hand which could present a safety issue. After affixing the stick to a tree, the hunter must return to the base of the tree to grab another stick, climb back of the tree, affix that stick, return to the base of the tree to grab another stick and so on until the desire height is reached. That presents a physical challenge. The present invention provides an improvement over the state of the art by providing a treestand and climbing stick comprising an integrated hook that makes climbing a tree in setting up a treestand and climbing sticks safer, easier and more efficient.

### SUMMARY OF THE INVENTION

The present invention generally relates to a treestand and climbing stick having integrated climbing hooks for use in climbing trees for hunting or other purposes. The integrated climbing hook makes setting up a treestand and climbing sticks safer, more efficient and less strenuous. The integrated climbing hook allows a stand or sticks to attach to a waist belt, mole webbing, safety harness, backpack, saddle, pocket, etc. or any similar item on your person while ascending a tree to set up your treestand and/or sticks. Having easy access to your sticks and treestand while climbing a tree allows for a safer, more efficient and less strenuous ascent.

### BRIEF DESCRIPTION OF THE FIGURES

FIG. 1 is a side view illustrating a climbing stick comprising an integrated climbing hook in accordance with the invention.

FIG. 2 is a frontal view of a one piece climbing stick of the invention.

FIG. 3 is a side view of a climbing stick with integrated climbing hook attached to a climbing belt.

FIG. 4 shows a treestand with integrated climbing hook attached to a climbing belt.

FIG. 5 shows a climbing stick and saddle treestand with integrated climbing hook attached to a climbing belt.

### DETAILED DESCRIPTION OF THE INVENTION

The present invention generally relates to a treestand and climbing stick for use in climbing trees for hunting or other purposes comprising an integrated climbing hook. The integrated climbing hook is configured to allow a stand or sticks to attach to a waist belt, mole webbing, safety harness, backpack, saddle, pocket, etc. or any similar item on your person. This allows the hunter to have both hands free while ascending a tree to set up your treestand and/or sticks. Having easy access to your sticks and treestand while climbing a tree allows for a safer, more efficient and less strenuous ascent.

Successful hunters, especially mobile hunters, require quick and easy stand and stick setup procedure. Unfortunately, hanging a portable treestand and climbing sticks has been a time consuming and exhausting process since the beginning due to the amount of gear one uses. A hunting setup typically consists of a treestand and a plurality of climbing sticks, typically one to six, depending on the hunter's preference or particular situation. Traditionally, a hunter was forced to attempt climbing a tree while holding a stick in his hand and after affixing that stick section to the tree, returning to the base of the tree to grab the next stick section, ascending up the tree, affixing that stick section, returning to the base of the tree to grab the next section, ascending up the tree and affixing that section, and so on until the hunter has reached the desired hunting height wherein the treestand is set up. With climbing sticks and treestand having climbing or ascender hook according to the invention the hunter can now attach each additional climbing stick and/or stand to his person, which allows the hunter to climb the tree with both hands free and eliminates the need to make trips up and down the tree repeatedly. Climbing sticks and/or treestand comprising the climbing or ascending hook of the invention also allows hunters to avoid unsafe procedures while setting up said sticks and stand and eliminates the need to invest in costly third-party accessories that increase their setup weight and complicate the setup process.

The climbing or ascending hook can be of any shape provided that it can effectively catch, hold, hang, attach, and/or hang a climbing stick or treestand to an article worn by the user such as a waist belt, mole webbing, safety harness, backpack, saddle, pocket, etc. or any similar item on your person. This allows the user to have both hands free while climbing a tree to set up his/her treestand and/or sticks. In one embodiment the integrated hook is preferably a hook shaped protrusion extending out from the main embodiment or center support section of a climbing stick or treestand which is configured to allow said stick or treestand to attach to a climbing belt or similar article worn by the user. In another embodiment the climbing hook is curved or bent material that is rounded or hook shaped protruding from a climbing stick or treestand. In another embodiment the hook is partially of fully squared off, and in yet another embodiment it can take the shape of an eye hook, The hook can be fabricated from metal, plastic or any other material of sufficient strength to attach and hold said stick or treestand to an article worn by the user. In one embodiment the hook is fabricated from the same material as the climbing stick or treestand.

The climbing hooks of the invention can be affixed to a climbing stick or treestand through use of a bracket, bolts, straps, screws, fasteners, clips, U-clamps or various other affixing means, or it can be integrated as part of the climbing stick or treestand one-piece design.

Climbing sticks generally have a simple construction comprised of a number of individual alternating steps secured to an elongate center support structure. In one embodiment, the individual steps are pivotably mounted to the center support member, allowing the steps to rotate from a closed, vertical position when the module is in transport or is not in use, to an open, horizontal position where the step points outward perpendicular to the support member to provide alternating stepping surfaces for the individual utilizing the climbing stick. The climbing stick can be of any design or construction. In one embodiment it is of hollow tube design, where the center support structure is a hollow metal tube that is either squared or rounded. In another embodiment the center support structure can be machined, water-jetted and/or cut from a solid material by any conventional means. In yet another embodiment the climbing stick is of one-piece design which is described hereinbelow. Regardless of the configuration or construction, in accordance with the invention, the climbing stick comprises a climbing hook that is either affixed to the stick or is integrated as part of a solid center support structure or one-piece stick design.

In one embodiment the sticks are of hollow tube design with a climbing hook attached thereto. Sticks of hollow tube design are generally known in the art.

In another embodiment the sticks are similar to hollow tube sticks, except that the center support structure is fabricated from a single solid piece of metal, i.e., the center support structure is solid. Optionally, the center support structure can have an irregular geometric pattern machined or jetted out of the center support structure in order to lighten the weight thereof and to provide a degree of camouflage. Skilled hunters are aware that ordered structural patterns are generally an anomaly in the wild and, when seen by hunted animals, may keep them from approaching or cause them to flee.

In one preferred embodiment the present invention relates to a one-piece climbing stick with an integrated climbing hook for climbing trees for hunting purposes. The climbing sticks of the invention are characterized by a double step, one-piece design wherein the center support structure, the double steps and climbing or ascending hook emanating therefrom are fabricated from a single sheet or piece of aluminum and/or aluminum alloy. By “one piece” it is meant that center support structure, steps and a climbing hook emanating therefrom are all fabricated from a single sheet of stock, preferably aluminum stock, without the use of welds, rivets, screws, bolts and the like, i.e., it is one piece. The use of mechanical fasteners in the fabrication of climbing sticks creates joints which inherently are not completely rigid and as a result may move and squeak or create other noises. The one-piece climbing sticks of the invention overcome the deficiencies of the prior art by avoiding welds or any other fastening methods resulting in a stronger, lighter, quieter climbing stick. Additionally, the integrated climbing hook allows a stand or sticks to attach to a waist belt, mole webbing, safety harness, backpack, saddle, pocket, etc. or any similar item on your person while ascending a tree to set up your treestand and/or sticks. Having easy access to your sticks and treestand while climbing a tree allows for a safer, more efficient and less strenuous ascent.

The individual one-piece climbing sticks of the invention are solid and of superior strength as they are one piece. The sticks can have one or more unitary single or double climbing steps that are perpendicular or substantially perpendicular to the center support structure.

The integrated climbing hook can take and shape or form as long as it allows one to attach or hang the climbing stick, or treestand as the case may be, to the user climbing a tree. More specifically, the integrated climbing hook should allow the sticks to attach to a waist belt, mole webbing, safety harness, backpack, saddle, pocket, etc. or any similar item on your person while ascending a tree to set up your treestand and/or sticks. Having the climbing sticks and/or treestand attached to the climber allows for easy access and a safer, more efficient and less strenuous ascent.

Each climbing stick is secured to the tree trunk by a securing belt attached at one end by a bolt to one side of the support member. The belt is releasably secured at its opposite end to a belt hook or fastener attached to the center support member opposite the belt.

The climbing sticks of the invention are, when necessary, strengthened by heat treatment or other strengthening methods in order to strengthen the metal to the desired degree. Various other methods of strengthening the metal of the climbing steps of the invention are also included within the scope of this invention.

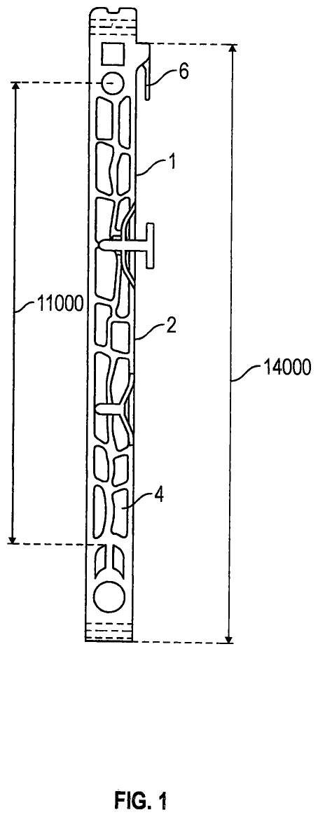

In one embodiment, the sticks of the invention are of a double step design. By double step it is meant that the left and right steps are generally perpendicular to and in the same plane as the center support structure. This double step design with integrated climbing hook is illustrated in FIG. 1. The double steps of the invention also optionally comprise foot grips cut into the left and right stepping sections of the double steps allowing for a non-slip stepping surface for the user when climbing. The double steps can also be angled slightly upwards from the horizontal in order to prevent the users foot from sliding off the step when climbing. In one embodiment, the double steps are perpendicular with the center support structure. In another embodiment the double steps are angled from about 1 to about 20 degrees from the horizontal plane; in another embodiment from about 5 to about 20 degrees and in yet another embodiment from 10-15 degrees from the horizontal plane.

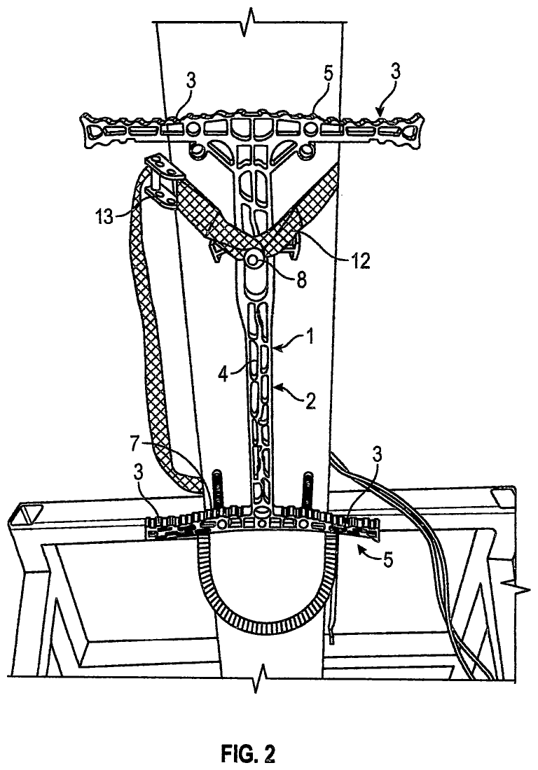

The climbing sticks of the invention also preferably comprise two or more support bolts or similar support structures mounted to the uppermost double step, wherein one support bolt is mounted to the left stepping portion of said double step and a second support bolt is mounted to the right stepping portion of the double steps as illustrated by FIG. 2. In another embodiment, the sticks of the invention comprise two support bolts mounted on the left and right stepping portions of both the uppermost double step and the bottom double step of said climbing stick. The support bolts engage and grip the tree on which the stick is placed to prevent the stick from slipping up or down or side to side on the tree. In one embodiment, the support bolts are adjustable, i.e., they can be lengthened or shortened depending on the needs of the user and the distance that the user wants the sticks to be secured away from the tree. The support bolts can be straight or can be angled in order to maximize grip on the tree. In one embodiment, the support bolts are angled 1-30 degrees, in another embodiment 1-25 degrees, in another embodiment 3-20 degrees and in another embodiment 5-15 degrees from the vertical plane of the center support structure.

In another embodiment, each stick also comprises receiving ports or holes configured to receive the two or more support bolts of a companion stick, which allows one to securely nest and attach two or more sticks to each other snugly for transport. These receiving ports or holes are preferably located at pre-determined locations proximate to the top and/or bottom double steps of the climbing stick. In another embodiment, each stick comprises a receiving port configured to receive the Versa button of another stick such that two or more sticks can be securely nested one to the other.

In another embodiment, the sticks of the invention also comprise one or more support brackets instead of support bolts, wherein said brackets are mounted to the center support member. The brackets are generally V-shaped and include a number of teeth on the interior surface of the bracket adapted to engage the tree on which the stick is placed in order to prevent the climbing stick from slipping from the tree. The support brackets are mounted at the top and optionally the bottom end of the support member. The brackets also pivot allowing them to become flush with the body of the stick to minimize profile when stacking the sticks for transport or attachment to a treestand. More specifically, the brackets that grip the tree when climbing and pivot 180°, in another embodiment 360° allowing them to become flush with the body of the stick to minimize the profile thereof and allow two or more sticks to nest closely together so that they can be easily carried/secured to a treestand. The pivoting feature of the support bracket of the invention is applicable to any climbing stick design and is not limited to the preferred embodiments or sticks described herein.

Finally, the climbing sticks are characterized by having an irregular geometric pattern machined or jetted out of the support member and/or steps. Skilled hunters are aware that ordered structural patterns are generally an anomaly in the wild and, when seen by hunted animals, may keep them from approaching or cause them to flee.

The climbing step of the invention comprises a securing arrangement used to secure the climbing stick to a tree. The arrangement includes a belt fastener disposed on the support member between the upper double step and the lower double step. In one embodiment, the fastener is comprised of a stem extending outwardly from the support member and a radially extending flange attached to the stem opposite the support member that covers the stem. The flange, or Versabutton™ provides an attachment point for a belt forming the remaining portion of the improved securing arrangement utilized with the climbing stick. The belt is comprised of a pair of straps, each including a loop at one end. The loops on each strap are placed over the flange of the fastener to secure the loops to the fastener on the support member. One of the straps includes an adjustable buckle attached to the strap opposite the loop that engages the non-loop end of the remaining strap to releasably secure the belt about the trunk of the tree. The loop and fastener arrangement of the present invention allows the securing belt to be secured about the tree trunk with the buckle positioned on either side of the support member, so that the buckle may be selectively positioned to avoid any limbs, branches or other obstructions that may prevent the securing belt from performing properly. The securing strap is an elongate strap of a durable material, such as nylon, that includes a free end and a loop integrally formed in the strap opposite the free end. The securing strap is removably attached to the fastener by placing the loop around the retaining flange of fastener. The flange prevents the loop from disengaging from the fastener, maintaining the securing strap in attachment, with the center support structure.

This securing arrangement is also able to be used on other devices utilized by hunters that are secured to a tree, such as tree stands. The configuration of the securing arrangement allows the belt to be selectively and releasably positioned on the support member to avoid any interference with the belt by limbs or branches extending from the tree. The strap for attachment to the tree comes through the stick from back to front allowing you the option of going around the tree in either direction opposed to the strap coming out of one side. The belt is comprised of a securing strap, a buckle strap, and a releasable buckle.

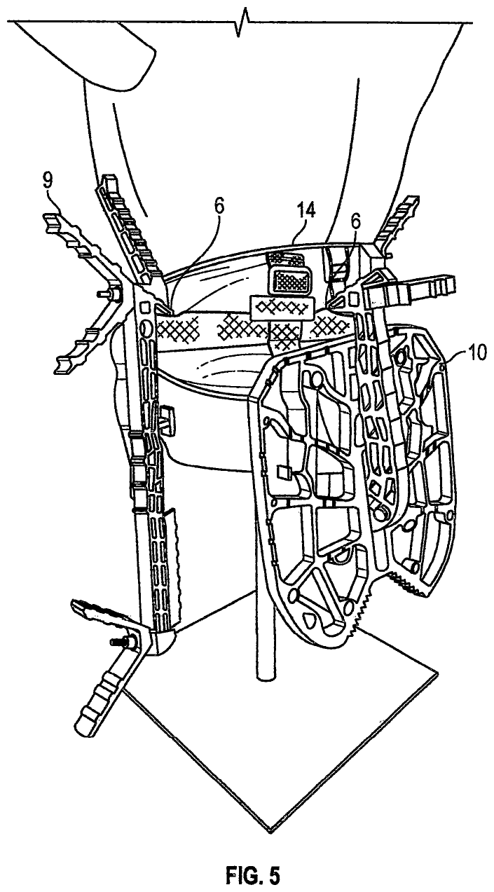

As an alternative to the flange Versabutton™ design, the climbing stick of the invention can have attachment anchor fabricated as part of the one-piece design for streamline attachment, as illustrated by FIG. 5. The attachment anchor serves as a wedge for rope attachment opposed to dual cam mechanisms. Other releasable securing arrangements can be utilized instead of belts, including chains, cables, ropes and the like.

The support member of the sticks optionally comprise hand grips cut right into the support member allowing for better grip when climbing. In one embodiment, the support member is not straight it jogs for added concealment and profile break up when in tree. Patterns and true edges are very unnatural in nature. The cutout designs cut out of support member of the sticks of the invention have no consecutive pattern to better blend in the wilderness.

In its broadest embodiment, the one piece climbing stick of the invention can be made of by any process, including machining from a solid metal workpiece such as aluminum or aluminum alloy and the like, and/or by a cast aluminum process. Any form of aluminum, aluminum alloy, or other metal/metal alloy can be used to fabricate the climbing stick of the invention provided that it is of sufficient strength and not excessively heavy.

One option to obtain a lighter climbing stick is to use a support structure machined from one-piece plate stock. This machining process solid allows one to fabricate solid center support structures, steps and climbing hook in one piece from a single piece of aluminum stock which is much lighter and stronger conventional sticks.

In another embodiment of the one piece climbing stick of the invention is fabricated from a single aluminum workpiece by a waterjet process, optionally an abrasive waterjet process. Fabricating a solid one-piece center support structure with an abrasive water jet process allows one to make one piece sticks that are even stronger and lighter than structures machined from one piece of plate stock. Utilizing a waterjet process allows one to reduce the wall thicknesses and still achieve the strength needed. Accordingly, the solid one piece climbing sticks of the invention made by waterjet process are among the strongest and lightest in the industry. Additionally, they are quieter and stealthier than prior art support structures that are generally of hollow tubular design. Water jet cutting uses an ultra-high-pressure stream of water to carry an abrasive grit. The abrasive does the cutting through a mechanical sawing action, leaving a smooth, precision cut surface. Waterjet is the most versatile process, because it is able to cut almost any type of material, including aluminum. Water jet is a very precise cutting process. It has a narrow kerf width, allowing fine contours to be cut, and producing high tolerance parts. The effect is to produce the parts you need for substantially lower cost, in substantially less time.

The water jet cutting process starts with an intensifier pump, which creates the ultra-high pressure (up to 90,000 psi) water pressure required for cutting hard materials. The Intensifier pump uses a hydraulic pressure over water system. A large horsepower motor drives a hydraulic pump, creating hydraulic pressure which powers a piston in a cylinder. The pressurized water is delivered to a cutting head by either high pressure tubing or hose. At the cutting head, the high pressure water is applied to an orifice with a typical diameter ranging from 0.005″ to 0.020″. This orifice is made in a diamond or sapphire, to resist abrasion of the high-pressure water. The orifice defines and creates the water stream which cuts through the material.

After the water stream exits the orifice, an abrasive can be added to the water stream, to allow it to cut hard materials. When cutting hard materials, including steel, stainless steel, aluminum, stone, wood, plastic, glass, etc., it is the abrasive that does the actual cutting using a mechanical sawing type action. The abrasive is usually crushed garnet, the same type of material often used as the abrasive on sand paper. Some special applications utilize other abrasive types.

The strength increase provided by a solid unitary aluminum construction by waterjet process allows a reduction in size and weight of the climbing stick of the invention. The solid construction also reduces the transmission of noise more common in constructions utilizing hollow tubular center structural members.

Finally, the entire outer surface of the climbing stick of the invention can be anodized with an irregular contrasting pattern to further enhance its camouflage appearance.

FIGS. 1-5 illustrate the climbing stick 1 and treestand 10 of the invention. Referring to FIG. 1, the climbing stick 1 includes a solid elongate center support structure 2 that functions as the body of the climbing stick, and two or more steps emanating therefrom 3 and an integrated climbing hook 6. The center support structure 2 optionally comprises hand grips cut right into the support member allowing for better grip when climbing. In one embodiment, the support member is not straight, it jogs for added concealment and profile break up when in tree. Patterns and true edges are very unnatural in nature. The cutout designs 4 cut out of support member of the sticks of the invention have no consecutive pattern to better blend in the wilderness. The cutout pattern 4 is best shown in FIG. 1.

FIG. 2 depicts a one piece climbing stick wherein the center support structure 2 includes two double steps 3 to provide a left and right stepping surface for an individual using the ladder module 1. The sticks of the invention can be lengthened to include three or more double steps if desired. The stepping portion of the double steps optionally include a number of grooves or gripping cutouts 5 spaced along its length. The grooves provide traction for the foot of the individual utilizing the step 1 to help prevent the foot from slipping off the stepping portion of the step.

The double steps 3 provide a horizontal stepping surface on both sides of the center support member 2. Alternatively, the stepping surface can be slightly angled upward from the horizontal as a further preventative measure against slippage.

In one embodiment, the climbing sticks of the invention comprise two or more support bolts 7 mounted to the left and right side of the double steps 3. In one embodiment, the sticks of the invention comprise two support bolts 7 mounted on the left and right side of the top double step 3. In another embodiment, the sticks of the invention comprise two support bolts 7 mounted on the left and right side of both the top and bottom double step 3. The support bolts 7 engage and grip the tree on which the stick is placed to prevent the stick from slipping up or down or side to side on the tree. The support bolts can be straight or can be angled in order to maximize grip on the tree. In one embodiment, the support bolts are angled 1-30 degrees from the horizontal or vertical plane.

In another embodiment, each stick also comprises receiving ports or holes configured to receive the support bolts 7 of another stick, which allows one to securely nest and attach two or more sticks to each other snugly for transport. These receiving ports or holes are preferably located at pre-determined locations proximate to the top and/or bottom double steps 3 of the climbing stick 1. In another embodiment, each stick comprises a receiving port configured to receive the Versa button 8 such that two or more sticks can be securely nested one to the other.

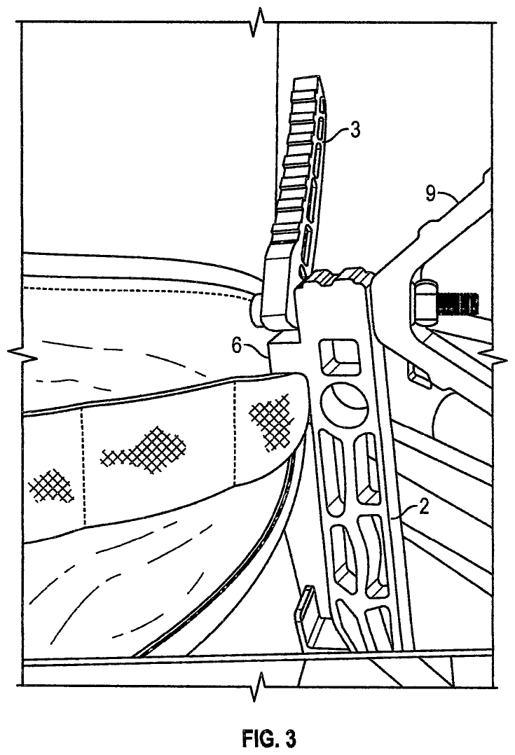

In an alternative embodiment and as shown if FIG. 3, instead of said support bolts 7, the center support structure 2 includes a pair of support brackets 9 mounted adjacent the top end and bottom end of the support structure 2. The brackets are generally V-shaped, including an interior surface and an exterior surface and are the rotatably mounted to each end of the support member to allow each bracket to independently conform to the direction in which the tree trunk extends. The brackets that grip the tree when climbing pivot allowing them to become flush with the body of the stick to minimize profile and to allow the sticks to nest closely together so that they can be easily carried/secured to the treestand of the invention. In one embodiment the brackets pivot 180°, and in another embodiment, they pivot 360° to allow said brackets to rest flush with the body or center support structure of the sticks.

The brackets optionally include a number of teeth spaced along the length of each side of bracket that are generally triangular in shape having a point extending outwardly from the interior surface of bracket. The teeth on bracket engage the trunk of the tree to prevent the module 1 from sliding down the tree when a person is climbing a tree.

Referring now to FIG. 2, the support member 2 also has a securing arrangement to hold the climbing stick 1 on the tree. A fastener or belt 12 is secured to the support member 2 between the double steps 3. The fastener includes a cylindrical mounting sleeve extending outwardly from the support member 2 and a circular retaining flange 8 or Versabutton™ positioned on the mounting sleeve opposite the support member 2. The flange 8 is preferably a metal washer or equivalent structure having a diameter significantly greater than the sleeve and including a hole in the center thereof. The sleeve and flange are secured to the support member 2 by a bolt inserted into the support member 2 through the hole in flange and through sleeve. The bolt extends through the support member 2 and is secured to the support member 2 opposite the fastener by a nut. The fastener 8 provides a point on the support member 2 used to removably attach each end of a securing belt to the support member 2 in order to reliably secure the module 1 to the tree.

The belt 12 is comprised of a securing strap, a buckle strap, and a releasable buckle 13. The securing strap is an elongate strap of a durable material, such as nylon, that includes a free end and a loop integrally formed in the strap opposite the free end. The securing strap is removably attached to the fastener 8 by placing the loop around the retaining flange of fastener. The flange prevents the loop from disengaging from the fastener 9, maintaining the securing strap in attachment, with the support member 2.

The buckle strap is formed of the same material as the securing strap and also includes a loop at one end that is also removably attached to the fastener 8. However, the end of buckle strap opposite the loop is attached to the buckle, which is placed around the tree to receive the free end of securing strap to secure the climbing stick 1 on the tree.

To attach the climbing stick 1 to a selected tree, first, the securing strap and buckle strap are secured to the fastener 8 on support member 2 so that the securing arrangement and, namely, the buckle on buckle strap, will not be obstructed by any limbs extending from the tree. Next, the support bolts 7 are positioned against the center of the tree to position the support member 2 in a generally vertical direction on the tree. Then, the straps and of the securing belt are wrapped around the tree in opposite directions, and the free end of securing strap is inserted through the buckle 13. The securing strap is pulled tight through buckle to securely fasten the securing belt about the tree.

As an alternative to the flange Versabutton™ design 8, the climbing stick 1 of the invention can have attachment anchor fabricated as part of the one-piece design for streamline attachment. The attachment anchor serves as a wedge for rope attachment opposed to dual cam mechanisms.

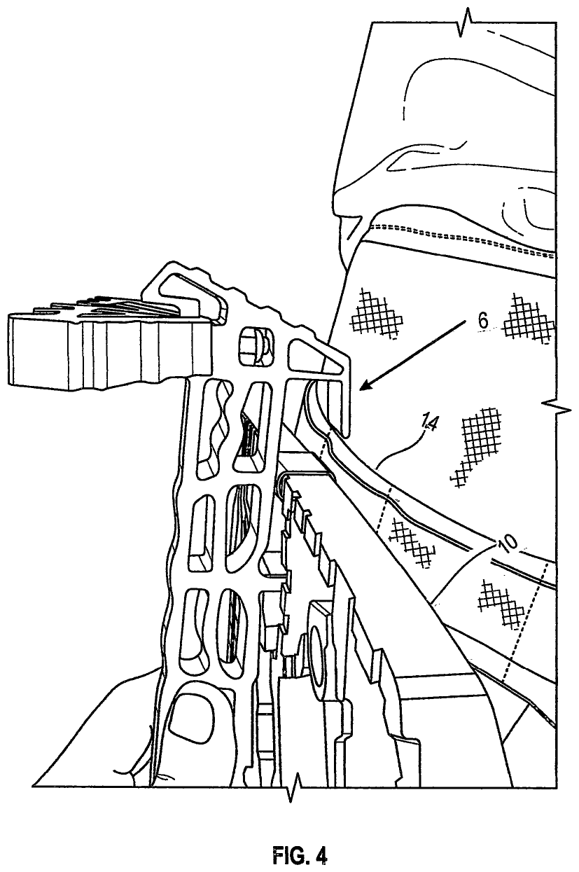

FIG. 4 shows a saddle type treestand 10 with climbing hook 6 according to the invention attached to a climbing belt 14. FIG. 5 shows both a one-piece climbing stick 1 and a saddle type treestand 10 attached via a climbing hook 6 to a climbing belt 14.

The invention also contemplates a lightweight, portable treestand comprising a climbing hook similar to that described with the climbing stick described above. The treestand can be of any typical construction, including but not limited to hollow tube design, grate design, cast aluminum design and/or one-piece design. Regardless of the design and construction, the invention contemplates a climbing hook affixed thereto to allow the treestand to be affixed to an article worn by the user as he/she climbs a tree. Alternatively, the climbing hook is integrated in the one-piece center support structure of a climbing stick or one piece center support structure or platform of a treestand.

The invention contemplates any type of treestand with a climbing hook attached thereto or integrated in the treestand design. In one embodiment the portable treestand comprises a platform, a center support structure and optionally a seat. The platform can be of any construction, as can the center support structure. In one embodiment the center support structure is of hollow tube design and in another embodiment, it can be of solid construction. With embodiments where the center support structure is solid, it can have an irregular geometric pattern machined or jetted out of the center support structure in order to lighten the weight thereof and to provide a degree of camouflage.

The invention also contemplates smaller “saddle” treestands comprising saddle like platforms that are popular with so-called mobile saddle hunters.

In another embodiment the invention contemplates a treestand of one-piece, rigid platform and/or a solid center support structure as opposed to a hollow tubular center support structure prevalent in the prior art. This solid center support is optionally characterized by a series of cutouts, in another embodiment irregular cutouts that reduce weight and provide a camouflage attribute to the treestand. The solid center support structure of the invention is far less noisy and much stealthier than the hollow tubular support structures of the prior art.

In one embodiment the treestand of the invention is characterized by a hang on seat that locks into foot platform creating a rigid structure capable of packing out game and or gear upwards of 100 lbs. More specifically, when packing up the stand for transport, the rear of the seat casting interlocks to the foot casting creating a shelf for transporting gear, meat, clothes, skull & cape etc. Essentially your stand doubles as an effective way to transport gear and could even take the place of a frame style pack if desired.

In another embodiment, the treestand of the invention also comprises a platform that comprises integrated attachment points for quiet and secure transporting of climbing sticks, resulting the smallest profile transport of any hang-on climbing stick combo.

In yet another embodiment the teeth on the foot casting of the platform are drafted toward the tree allowing the stand to settle down when weight is applied without any additional movements. In one embodiment the teeth are angled, generally at least 5° below the horizontal plane of the platform, in another embodiment at least 10° below the horizontal plane of the platform, in another embodiment at least 15° below the horizontal plane of the platform, and in yet another embodiment from 20-35° below the horizontal plane of the platform.

In its broadest embodiment the treestand of the invention can be made of by any process, including machining from a solid metal workpiece, including aluminum and the like, and/or by a cast aluminum process. Any form of aluminum, aluminum alloy, or other metal/metal alloy can be used to fabricate the treestands of the invention provided that they are sufficient strength and not excessively heavy.

One-piece cast aluminum platforms are the benchmark for a one-piece lightweight treestand platform. However today, there is high demand for even lighter weight treestands. The strongest currently available material practically employed in fabricating cast treestand platforms is 356t6 aluminum. Such castings have reached their plausible limit due to size and weight to strength ratio.

The other option to obtain a lighter treestand platform is to use a non-casted platform and/or seat and/or solid support structure machined from one-piece plate stock. This machining process allows one fabricate platforms that are much lighter and stronger than cast platforms, but at a significantly greater cost.

In one preferred embodiment of the invention the platform is fabricated from a single aluminum workpiece by a waterjet process, optionally an abrasive waterjet process. Optionally, the treestand seat is also fabricated from a single aluminum workpiece by a waterjet process, in one embodiment an abrasive waterjet process. Finally, the solid center support structure is also fabricated from a single aluminum workpiece by a waterjet process, preferably a waterjet process. Fabricating one-piece platforms with an abrasive water jet process allows one to make platforms that are even stronger and lighter than platforms machine from one piece of plate stock. Utilizing a waterjet process allows one to reduce the wall thicknesses of the platform and still achieve the strength needed. Accordingly, the one-piece platforms of the invention made by waterjet process are among the strongest and lightest platforms in the industry. The waterjet process allows for the fabrication of a one-piece treestand platform that is stronger, lighter and cheaper to make than cast aluminum platforms. Similar benefits are realized by fabricating the treestand seat and solid center support structure by a waterjet process, in one embodiment an abrasive waterjet process.

Various modes of carrying out the present invention are contemplated as being within the scope of the following claims particularly pointing out and distinctly claiming the subject matter which is regarded as the invention.

I claim:

1. A climbing stick configured to be releasably securable to a tree, said climbing stick comprising a climbing hook configured to allow said stick to attach to a user while said user is ascending said tree.

2. The climbing stick of claim 1 wherein said stick comprises a center support structure and a plurality of steps and said climbing stick is configured to attach said stick to a climbing belt, waist belt, mole webbing, safety harness, backpack, saddle, pocket and the like.

3. The climbing stick of claim 1 wherein said climbing hook is rounded or partially or wholly squared off and is affixed to the climbing stick.

4. The climbing stick of claim 3 wherein said climbing hook is affixed to said climbing stick by one or more clamps, bolts, screws, straps, fasteners or clips.

5. The climbing stick of claim 2 wherein said stick comprises a center support structure having an upper section and a lower section with a climbing hook fabricated therein and at least two double steps, wherein a first double step is fabricated proximate to the uppermost section of the center support structure and a second double step is fabricated proximate to the lowermost section of said center support structure, wherein said climbing stick is fabricated from a single sheet of aluminum or aluminum alloy.

6. The climbing stick of claim 5 wherein each double step comprises a left and right step each comprising a stepping surface, wherein said double step is in the same plane of and perpendicular to the center support structure.

7. The climbing stick of claim 6 wherein the left and right step of said double step is angled from 1 to about 20 degrees upward from the horizontal plane, wherein said steps optionally comprise foot grips molded or cut into the stepping surfaces of said double steps allowing for a non-slip stepping surface for the user when climbing.

8. The climbing stick of claim 5 comprising at least two support bolts configured to securely engage a tree when in use wherein a first support bolt is mounted to the left step of the uppermost double step and a second bolt is mounted to the right step of the uppermost double step, wherein the length of the support bolts is optionally adjustable and said support bolts are angled outward at an angle of from 1 to 20 degrees from the plane that is perpendicular to the center support structure.

9. The stick of claim 8 wherein support bolts are mounted to the lowermost double steps of said one-piece stick wherein a first support bolt is mounted to the left step of the lowermost double step and a second bolt is mounted to the right step of the lowermost double step.

10. The climbing stick of claim 5 comprising at least two receiving ports or holes proximate to the top and/or bottom double steps of the climbing stick, wherein said receiving ports are configured to receive the support bolts of another stick, allowing two or more sticks to be secured together.

11. The climbing stick of claim 2 comprising at least one stabilizing bracket mounted to the center support structure, wherein said stabilizing bracket is rotatable to allow said bracket to be flush with the support member allowing for the efficient nesting of two or more climbing sticks one to the other.

12. The climbing stick of claim 2 which additionally comprises at least one a fastener, wherein said fastener comprises a retaining flange mounted to the center support structure.

13. The climbing stick of claim 12 wherein said retaining flange is circular and optionally comprises a stem, wherein retaining flange is secured to the center support structure by a bolt inserted through the center of the retaining flange, optional stem and through the support structure and secured on the opposite side of said support structure by a fastener or a nut, wherein said circular retaining flange is configured to receive and securely engage a securing belt wherein said securing belt is selected from a strap, cable, rope or chain.

14. The climbing stick of claim 1 which is one piece and is fabricated from solid aluminum or aluminum alloy stock that is milled, machined, laser cut and/or water jetted, wherein said climbing hook is integrated in said one-piece stick.

15. A portable treestand for demountable attachment to a tree, said treestand comprising a climbing hook configured to allow said treestand to attach to a user while said user is ascending said tree.

16. The treestand of claim 15 further comprising a main supporting platform, said platform adapted to be attached at an inner platform edge to the tree trunk, and to extend generally horizontally outward from the trunk to an outer platform edge; said platform being of uniform, one-piece rigid construction having an open grate-like configuration; and, attachment means connected to said platform for attaching said platform to the tree, wherein the platform of the treestand is attached adjacent to its inner edge directly to a rigid center support structure.

17. The treestand of claim 15 wherein said one-piece platform, seat and/or center support structure are fabricated from solid aluminum stock.

18. The treestand of claim 19 wherein said climbing hook is fabricated in said one-piece platform or center support structure.

19. The treestand of claim 15 with is a saddle stand.

20. The treestand of claim 15 wherein said climbing hook is configured to attach said treestand to a climbing belt, waist belt, mole webbing, safety harness, backpack, saddle, pocket and the like.
